(19) United States
(12) Patent Application Publication
(10) Pub. No.: US 2010/0288180 A1
(43) Pub. Date: Nov. 18, 2010

(54) Automotive Power Window Intrusion Detection

(76) Inventor: Kelly M. Kohlstrand, Wyandotte, MI (US)

Correspondence Address: MACMILLAN, SOBANSKI & TODD, LLC, ONE MARITIME PLAZA - FIFTH FLOOR, 720 WATER STREET, TOLEDO, OH, 43604, US

(21) Appl. No.: 12/466,403

(22) Filed: May 15, 2009

(51) Int. Cl. G08B 13/08

(52) U.S. Cl. 116/75

(57) ABSTRACT

A system detects forced opening of a power window of a motor vehicle. An electric motor is responsive to a drive signal to provide a torque to selectably open or close the window. A regulator couples the electric motor to the window for transferring the torque into an opening or closing force on the window. A sensor is coupled to the electric motor responsive to a back voltage produced by the electric motor when an external force on the window glass opens the window glass when the drive signal is not present. A vehicle security system is coupled to the sensor for generating a perimeter alarm condition in response to detection of the back voltage by the voltage sensor.

### CROSS REFERENCE TO RELATED APPLICATIONS

Not Applicable.

### STATEMENT REGARDING FEDERALLY SPONSORED RESEARCH

Not Applicable.

### BACKGROUND OF THE INVENTION

The present invention relates in general to vehicle perimeter alarm systems, and, more specifically, to a sensor for detecting forced opening of a window of a motor vehicle.

Motor vehicles such as passenger cars and trucks are commonly provided with anti-theft systems for monitoring the vehicle and for generating various alarms when an unauthorized intrusion is detected. Various types of intrusion sensors are known such as a door ajar switches, vibration sensors, glass breakage sensors, and tilt switches. When a sensor detects a condition potentially related to an intrusion or theft (e.g., a door being opened without proper unlocking and disarming of the security system, or the tilting of the locked vehicle as when it is lifted onto a tow truck by a thief) an audible or visible alarm is created to draw attention to the vehicle. A wireless alarm signal can also be sent remotely to a receiver being carried by the owner of the vehicle to allow them to take appropriate action. In addition to generating an alarm, the anti-theft system may immobilize the engine so that the vehicle cannot be driven away until the alarm is reset by the owner.

A typical power window for a motor vehicle uses a window regulator system driven by an electric motor so that a user can raise or lower the window glass by operating an electrical switch. On a hot day, the vehicle user may desire to leave a window partially open while the vehicle is locked and unattended. Alternatively, the vehicle user may simply forget to close a window all the way when leaving their parked vehicle. Conventional window regulator systems have been designed to limit the ability of an intruder to manually force open a power window against the resistance created by the window regulator system and the motor. However, no mechanism has been found that is sufficiently cost effective that can prevent forced opening while still facilitating good operation under control of the motor.

With sufficient force, the resistance of a typical window regulator and motor can be overcome so that an intruder is able to force open a power window in order to access the vehicle interior. Depending upon the other intrusion sensors present in a vehicle, the ability to force open a window may bypass the ability to detect intrusions thereby making vehicle contents vulnerable to theft. Existing sensor technology such as ultrasonic or radar scanning can be used to monitor the vehicle interior, but such systems are very expensive.

### SUMMARY OF THE INVENTION

The present invention has the advantage of detecting the forcing open of a power window indicative of an intrusion without requiring expensive sensor technologies.

In one aspect of the invention, a system is provided for detecting forced opening of a window of a vehicle. An electric motor is responsive to a drive signal to provide a torque to selectably open or close the window. A regulator couples the electric motor to the window for transferring the torque into an opening or closing force on the window. A sensor is coupled to the electric motor responsive to a back voltage produced by the electric motor when an external force on the window glass opens the opens the window glass when the drive signal is not present. A vehicle security system is coupled to the sensor for generating a perimeter alarm condition in response to detection of the back voltage by the voltage sensor.

### BRIEF DESCRIPTION OF THE DRAWINGS

FIG. 1 is an exploded view of a vehicle door and its window regulator.

FIG. 2 is a schematic diagram showing a window control circuit of the prior art.

FIG. 3 is a block diagram showing one preferred embodiment of the invention.

FIG. 4 is a schematic diagram showing another embodiment in greater detail.

FIG. 5 is a block diagram showing yet another embodiment of the invention.

### DETAILED DESCRIPTION OF PREFERRED EMBODIMENTS

A typical power window uses a control switch, a reversible electric motor, and an up-down mechanism (known as a window regulator) for transferring the motor torque into a sliding motion of the window glass. FIG. 1 is an exploded view of a door 10 receiving a window glass 11 connected to a window regulator mechanism 13 by a plurality of spacers 12 and rivets or bolts (not shown). An electric motor 14 is mounted to door 10 and is coupled to window regulator 13 so that motor rotation causes window glass 11 to move up and down within a top run 15. Due to the coupling between regulator 13 and motor 14, when window glass 14 is forced in the opening direction without a drive signal being applied to motor 14, then motor 14 rotates in the window-opening direction whenever sufficient opening force is applied externally to window glass 11.

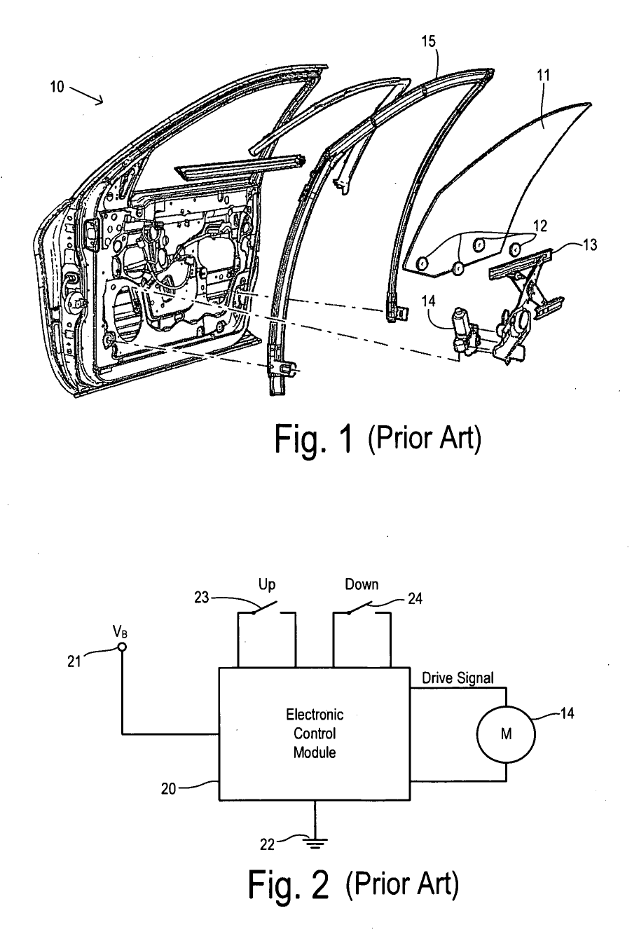

FIG. 2 shows a first type of control circuit for driving motor 14. An electric control module 20 receives power from its connections to a battery voltage 21 and ground 22. Module 20 may be comprised of a door module contained within the door which controls various functions relating to the door including power window operation, for example. An up switch 23 and a down switch 24 are coupled to module 20 for providing corresponding control signals when activated manually by a user. Module 20 includes conventional logic for generating a drive signal to be applied to motor 14 in order to appropriately open or close the window. The present invention can also be used with other types of power window control circuits, such as when a battery voltage is directly applied to the motor via the up and down switches.

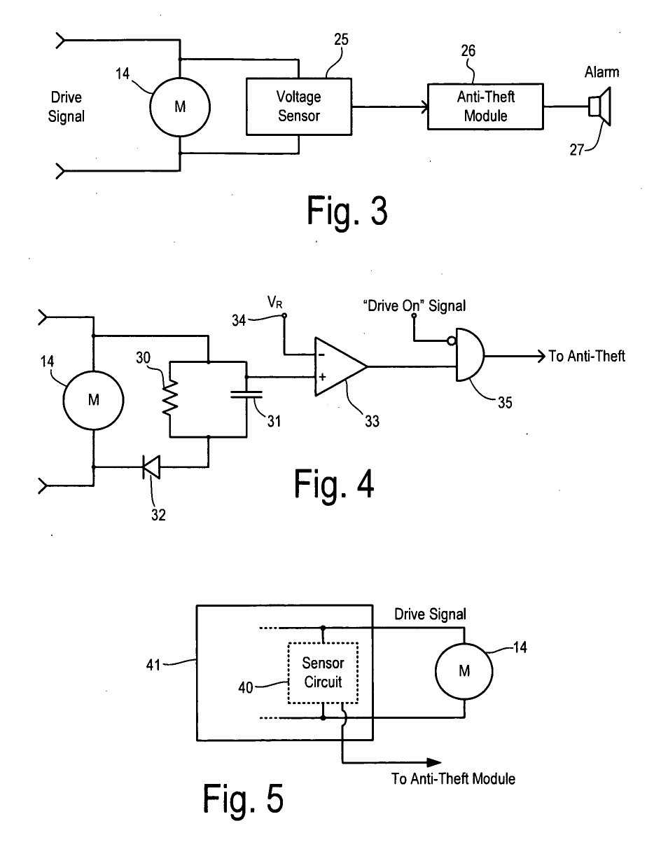

A first embodiment for detecting a forced opening of a power window is shown in FIG. 3. During forced movement of the window (as when it is manually forced by an intruder), a resulting movement within motor 14 generates an induced voltage across motor 14. This “back voltage” produced by motor 14 is detected by a sensor 25, preferably comprised of a voltage sensor. If the back voltage is present when the drive signal is not being applied to motor 14, then the back voltage is indicative of the window glass being forced open by an external force. A detection signal is provided from sensor 25 to an anti-theft module 26 which can take action in response to the attempted intrusion. More specifically, the presence of the back voltage indicates the existence of a perimeter alarm condition in which anti-theft module 26 should generate an alarm (e.g., an audible alarm using a loudspeaker 27). Other actions taken according to the perimeter alarm condition can include visual alarms (e.g., flashing the exterior lights) or inhibiting engine starting in order to immobilize the vehicle. The detection signal may be provided to anti-theft module 26 via a multiplex bus linking various electronic modules within the vehicle, such as a CAN bus, for example.

FIG. 4 shows another embodiment of the back voltage sensor in greater detail. An RC parallel circuit is connected across motor 14. An optional diode 32 couples resistor 30 and capacitor 31 to one side of motor 14 so that a drive signal applied to motor 14 for the closing direction will not be affected by the sensor circuit.

When the back voltage is generated during forced opening of the window, the back voltage is accumulated across capacitor 31. Resistor 30 provides a decay path for the accumulated voltage and has a sufficiently high resistance so that the decay does not effect the detection of the back voltage and so that the detection circuit also does not significantly affect the drive signal during normal motor operation in the opening direction.

The accumulated back voltage on capacitor 31 is applied to a non-inverting input of a comparator 33. A predetermined reference voltage VR at a terminal 34 is applied to an inverting input of comparator 33. When the back voltage is greater than the predetermined reference voltage, a positive output signal is generated by the output of comparator 33 and applied to a non-inverting input of an AND-gate 35. AND-gate 35 has an inverted input receiving a “drive on” signal from the power window control module. AND-gate 35 acts as a transmission gate so that an alarm indication signal is provided at the output of AND-gate 35 only when the drive signal is not present. The “drive on” signal is preferably a logic level signal generated by the power window controller simultaneously with the drive signal applied to motor 14. Thus, a detection signal corresponding to the back voltage is inhibited even when the voltage across capacitor 13 exceeds the predetermined reference voltage whenever the drive signal is present.

The sensor circuitry for the back voltage detector of FIGS. 3 or 4 can be constructed to be integrally mounted to the window regulator or to the motor, for example. As shown in FIG. 5, the sensor circuit 40 can also be incorporated into the door control module 41. Consequently, the only external wiring modification needed in a corresponding vehicle is to add an electrical line between control module 41 and the anti-theft module in order to indicate the perimeter alarm condition.

What is claimed is:

1. A system for detecting forced opening of a window of a vehicle, comprising:
an electric motor responsive to a drive signal to provide a torque to selectably open or close the window;
a regulator coupling the electric motor to the window for transferring the torque into an opening or closing force on the window;
a sensor coupled to the electric motor responsive to a back voltage produced by the electric motor when an external force on the window glass opens the window glass when the drive signal is not present; and
a vehicle security system coupled to the sensor generating a perimeter alarm condition in response to detection of the back voltage by the voltage sensor.

2. The system of claim 1 wherein the sensor comprises a comparator that is activated when the back voltage exceeds a predetermined reference voltage.

3. The system of claim 2 further comprising a gate coupled to the comparator that inhibits detection of the back voltage when the drive signal is present.

4. The system of claim 1 wherein the drive signal is generated in an electronic control module located remotely from the electric motor, and wherein the sensor comprised electrical components contained within the electronic control module.
